(19) United States
(12) Patent Application Publication
(10) Pub. No.: US 2017/0195563 A1
(43) Pub. Date: Jul. 6, 2017

(54) BODY-MOUNTABLE PANORAMIC CAMERAS WITH WIDE FIELDS OF VIEW

(71) Applicant: 360fly, Inc., Canonsburg, PA (US)

(72) Inventors: Claudio Santiago Ribeiro, Evanston, IL (US); Michael John Harmon, Fort Lauderdale, FL (US); Billy Robertson, Pompano Beach, FL (US); Moisés De La Cruz, Cooper City, FL (US); John Nicholas Shemelynce, Fort Lauderdale, FL (US); Michael Rondinelli, Canonsburg, PA (US)

(21) Appl. No.: 14/988,499

(22) Filed: Jan. 5, 2016

(51) Int. Cl. H04N 5/232; G02B 13/06; H04N 5/225

(52) U.S. Cl. CPC H04N 5/23238; H04N 5/2252; H04N 5/2254; H04N 5/23293; H04N 5/23216; G02B 13/06

(57) ABSTRACT

A low-profile panoramic camera is disclosed comprising an elongated camera body and a panoramic lens. The panoramic lens has a principle longitudinal axis and a field of view angle of greater than 180°. A portion of the camera body adjacent to the panoramic lens comprises a surface defining a rake angle that is outside the field of view angle. The panoramic camera has a total height less than a length of the camera body.

### FIELD OF THE INVENTION

The present invention relates to panoramic cameras with wide fields of view that may be mounted at various locations on a user.

### BACKGROUND INFORMATION

Conventional video cameras may be mounted on various types of equipment in order to record many types of events. However, a need exists for body-mountable panoramic cameras capable of capturing a wide field of view.

### SUMMARY OF THE INVENTION

An aspect of the present invention is to provide a low-profile panoramic camera comprising an elongated camera body, and a panoramic lens having a principle longitudinal axis and a field of view angle of greater than 180°, wherein a portion of the camera body adjacent to the panoramic lens comprises a surface defining a rake angle that is outside the field of view angle, and the panoramic camera has a total height less than a length of the camera body.

This and other aspects of the present invention will be more apparent from the following description.

### BRIEF DESCRIPTION OF THE DRAWINGS

FIG. 1 is an isometric view of a panoramic camera in accordance with an embodiment of the present invention.

FIG. 2 is a top view of the panoramic camera of FIG. 1.

FIG. 3 is a front view of the panoramic camera of FIG. 1.

FIG. 4 is a back view of the panoramic camera of FIG. 1.

FIG. 5 is a left side view of the panoramic camera of FIG. 1.

FIG. 6 is a ride side view of the panoramic camera of FIG. 1.

FIG. 7 is a bottom view of the panoramic camera of FIG. 1.

FIG. 8 is a longitudinal sectional view of a panoramic camera taken through Section 8-8 of FIG. 2 in which the panoramic camera is mounted in a mounting base, which is also shown in a longitudinal sectional view.

FIG. 9 is a cross-sectional view of a panoramic camera taken through Section 9-9 of FIG. 2 with the panoramic camera mounted in a mounting base, which is also shown in a cross-sectional view.

FIG. 10 is a cross-sectional view of a panoramic camera taken through Section 10-10 of FIG. 2 with the panoramic camera mounted in a mounting base, which is also shown in a cross-sectional view.

FIG. 11 is an isometric view of a panoramic camera mounting base in accordance with an embodiment of the present invention.

FIG. 12 is a top view of the mounting base of FIG. 11.

FIG. 13 is a front view of the mounting base of FIG. 11.

FIG. 14 is a back view of the mounting base of FIG. 11.

FIG. 15 is a left side view of the mounting base of FIG. 11.

FIG. 16 is a right side view of the mounting base of FIG. 11.

FIG. 17 is a bottom view of the mounting base of FIG. 11.

FIG. 18 is a partially schematic front view of a user with body-mounted cameras positioned at different locations on the user.

FIG. 19 is a partially schematic side view of a user with body-mounted cameras positioned at different locations on the user.

FIG. 20 is a side view of a lens for use in a panoramic camera in accordance with an embodiment of the present invention.

FIG. 21 is a side view of a lens for use in a panoramic camera in accordance with another embodiment of the present invention.

FIG. 22 is a side view of a lens for use in a panoramic camera in accordance with a further embodiment of the present invention.

FIG. 23 is a side view of a lens for use in a panoramic camera in accordance with another embodiment of the present invention.

FIG. 24 is a schematic flow diagram illustrating tiling and de-tiling processes in accordance with an embodiment of the present invention.

FIG. 25 is a schematic flow diagram illustrating a camera side process in accordance with an embodiment of the present invention.

FIG. 26 is a schematic flow diagram illustrating a user side process in accordance with an embodiment of the present invention.

FIG. 27 is a schematic flow diagram illustrating a sensor fusion model in accordance with an embodiment of the present invention.

FIG. 28 is a schematic flow diagram illustrating data transmission between a camera system and user in accordance with an embodiment of the present invention.

FIGS. 29, 30 and 31 illustrate interactive display features in accordance with embodiments of the present invention.

FIGS. 32, 33 and 34 illustrate orientation-based display features in accordance with embodiments of the present invention.

### DETAILED DESCRIPTION

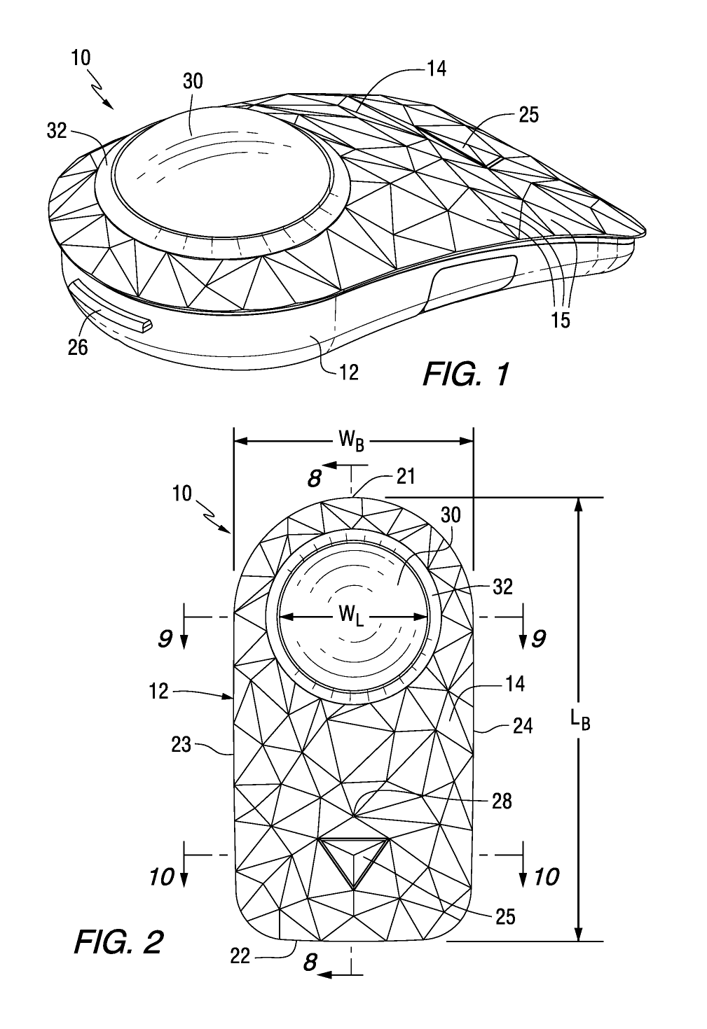

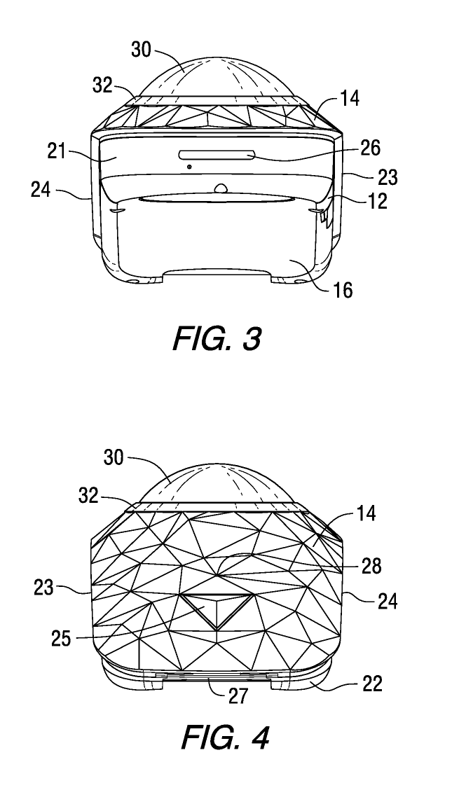

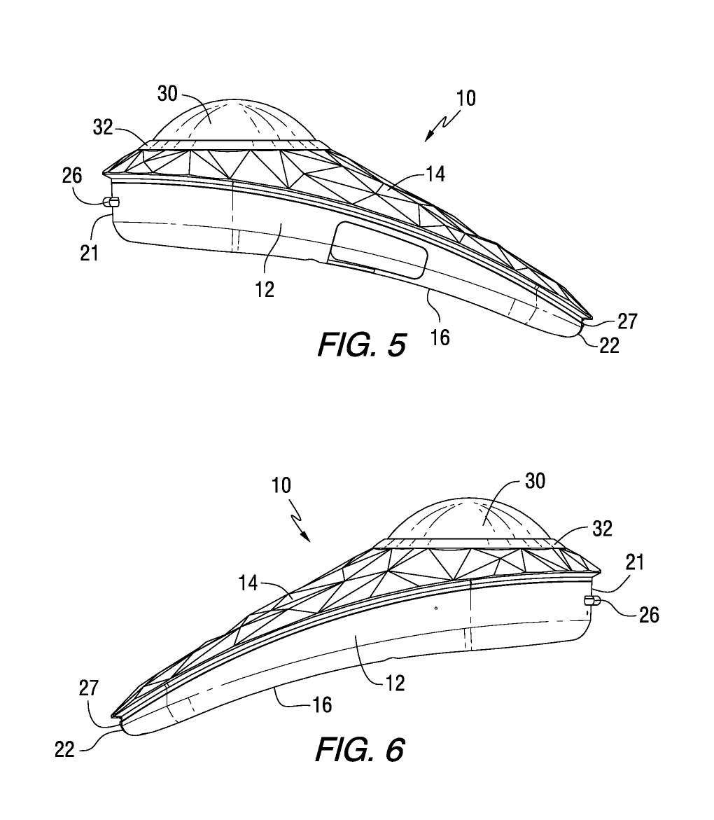

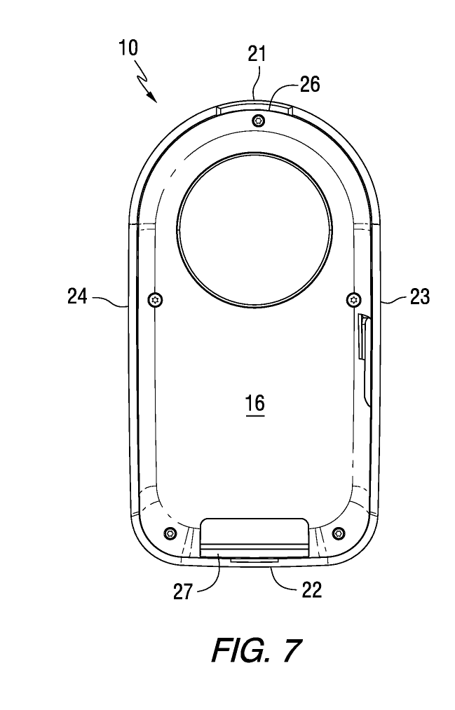

FIGS. 1-7 illustrate a low profile panoramic camera 10 in accordance with an embodiment of the present invention. The low profile panoramic camera includes an elongated camera body 12. As used herein, the term “low profile” means that the panoramic camera has a height, measured along a longitudinal axis of its panoramic lens, that is less than either the width or the length of the camera body 12. The term “elongated”, when referring to the shape of the camera body 12, means that the camera body 12 is not symmetrical around an axis of rotation defined by the longitudinal axis, but rather includes at least one portion that extends radially outward from the longitudinal axis a greater distance than the remainder of the camera body 12.

The elongated camera body 12 of the low-profile panoramic camera 10 includes a top surface 14 and a bottom surface 16. In the embodiment shown, the top surface 14 comprises a faceted surface including multiple facets 15 having substantially flat surfaces lying in planes slightly offset from each adjacent facet, with most of the individual facets 15 having a triangular shape. However, some of the facets 15 may have other shapes. Although the top surface 14 is faceted in the embodiment shown, it is to be understood that the top surface 14 may have any other suitable surface configuration, such as smooth, dimpled, knurled, or the like. The bottom surface 16 of the camera body 12 has a concave shape, as more fully described below.

The camera body 12 has a front end 21, back end 22, left side 23, and right side 24. Although the terms “front”, “back”, “left” and “right” are used herein, it is to be understood that the panoramic camera 10 may be oriented in many different directions during use, and such directional terms are used for purposes of description rather than limitation. A power button 25 is provided on the top surface 14. A retaining tab 26 extends from the front end 21 of the camera body 12. A retaining lip 27 is provided at the back end 22 of the camera body, under the rear portion of the top surface 14. A microphone hole 28 is provided through the top surface 14. The microphone hole 28 communicates with a microphone 29 provided inside the camera body 12, as more fully described below. A panoramic lens 30 is secured on the camera body 12 by a lens support ring 32.

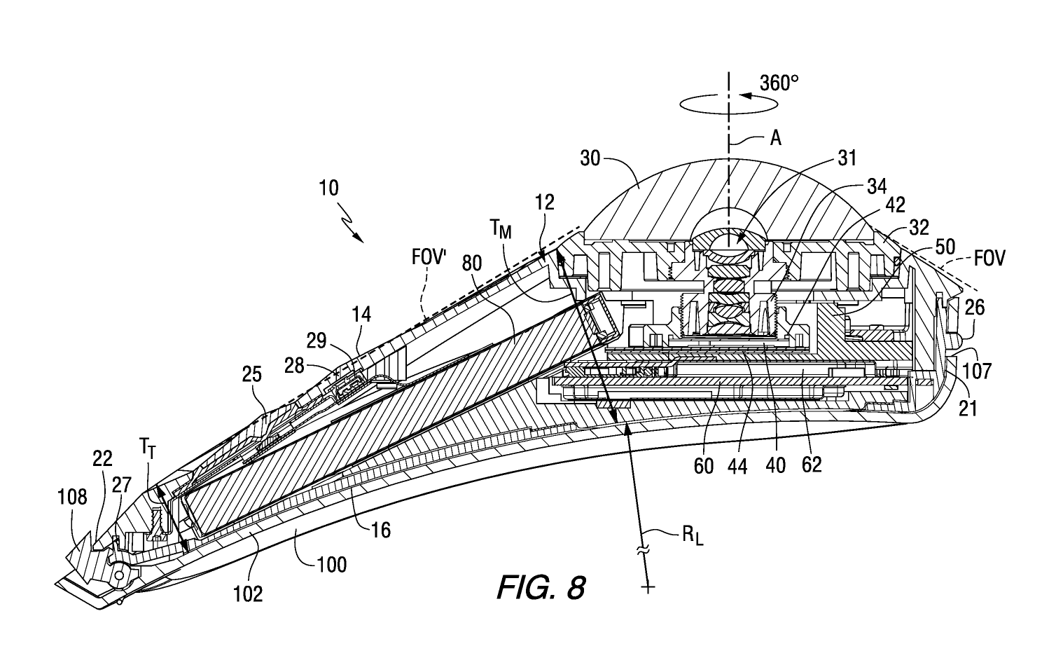

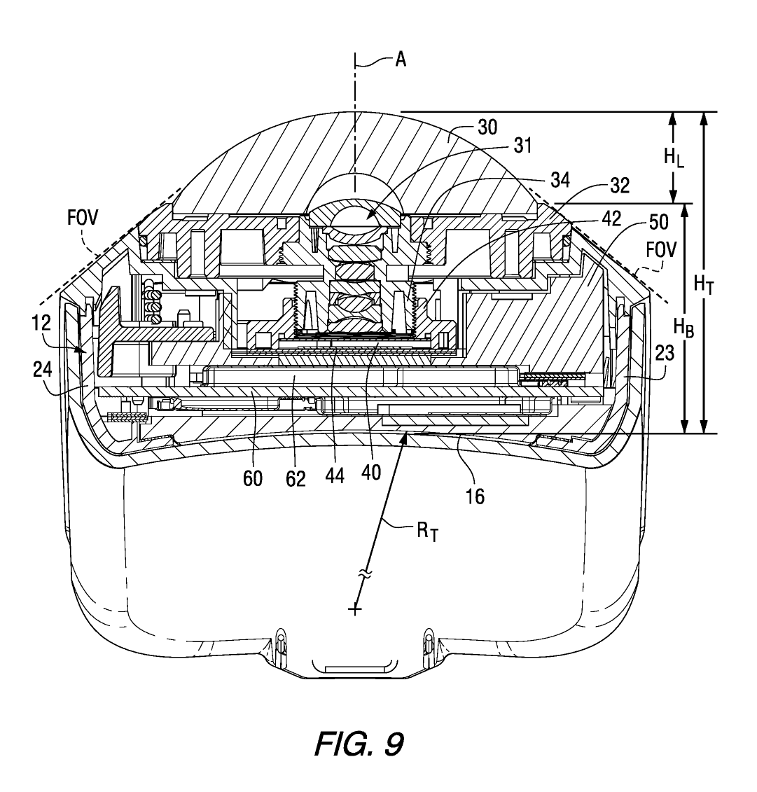

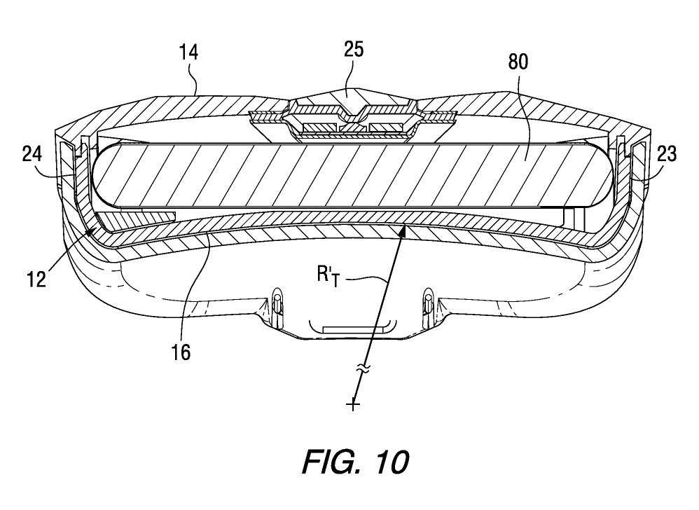

FIG. 8 is a longitudinal sectional view, and FIGS. 9 and 10 are cross-sectional views, of the panoramic camera 10. FIGS. 8-10 also include sectional views of a mounting base 100, which is described in more detail below. As shown in the longitudinal sectional view of FIG. 8, the panoramic camera 10 includes a panoramic lens 30 secured in the camera body 12 by the lens support ring 32. The lens 30 includes multiple lens elements that form a lens assembly 31, as more fully described below. The lens 30 has a principle longitudinal axis A defining a 360° rotational view. In the orientation shown in FIG. 8, the longitudinal axis A is vertical and the panoramic camera 10 and panoramic lens 30 are oriented to provide a 360° rotational view along a horizontal plane perpendicular to the longitudinal axis A. However, the panoramic camera 10 and panoramic lens 30 may be oriented in any other desired direction during use. As shown in FIGS. 8 and 9, the panoramic lens 30 also has a field of view FOV, which, in the orientation shown in the figures, corresponds to a vertical field of view. In certain embodiments, the field of view FOV is greater than 180° up to 360°, e.g., from 200° to 300°, from 210° to 280°, or from 220° to 270°. In certain embodiments, the field of view FOV may be about 230°, 240°, 250°, 260° or 270°.

In the embodiment shown, the lens support ring 32 is beveled at an angle such that it does not interfere with the field of view FOV of the lens 30. The bevel angle of the lens support ring 32 may correspond to the field of view FOV angle of the lens 30. In addition, the top surface 14 of the camera body 12 has a tangential surface or surfaces that are angled downward and away from the lens 30 in order to substantially avoid obstruction of the field of view FOV, as more fully described below.

In accordance with embodiments of the present invention, the shape and dimensions of the low-profile panoramic camera 10 and elongated camera body 12 are controlled in order to substantially avoid obstructions within the field of view FOV of the panoramic lens 30, while providing sufficient interior volume within the camera body 12 to contain the various components of the panoramic camera 10, and while maintaining a low profile.

FIGS. 2, 8, 9 and 10 illustrate various dimensions of the panoramic camera 10 in accordance with embodiments of the present invention. As shown in FIG. 2, the elongated camera body 12 has a length L_{B} and a width W_{B}. The panoramic lens 30 has a width L_{L} measured across the lens at the inner diameter of the lens support ring 32.

As shown in FIG. 2, the camera body 12 is elongated such that the back end 22 is further away from the center of the panoramic lens 30 than the front end 21. The elongated shape can be defined using the longitudinal axis A of the lens as a reference point and measuring the peripheral edge of the camera body 12 at various rotational locations around the longitudinal axis A. In the embodiment shown, the peripheral edge of the camera body at the front end 21 has a substantially constant radial distance from the longitudinal axis A in a 180° arc in the region where the front end 21 transitions into the left and right sides 23 and 24 of the camera body 12. A generally hemispherical configuration is thus provided near the front end 21 of the camera body 12, as shown in FIG. 2. In this region, the top surface 14 of the camera body 12 has a generally conical shape that falls outside the field of view FOV of the lens, as shown in FIGS. 8 and 9.

As further shown in FIG. 2, the back end 22 of the camera body 12 extends away from the central longitudinal axis A of the panoramic lens 30 a distance that is significantly greater than the distance between the front end 21 and the central longitudinal axis A of the panoramic lens 30. This distance at the back end 22 may be referred to as the “elongated distance” of the camera body 12, and may be at least 20 percent, or 30 percent, or 40 percent longer than the distance at the front end 21. For example, the elongated distance at the back end may be from 50 percent to 1,000 percent, or from 100 percent to 800 percent, or from 200 percent to 500 percent, of the distance at the front end. It is to be understood that, while the terms “front end” and “back end” are used to define the “elongated distance”, such terms are not intended to limit the direction of elongation, e.g., the elongated portion of the camera body may be facing rearward, forward, sideways, up, down, or any other orientation during use. Furthermore, while the camera body 12 shown in the figures has an elongation in a single direction from the panoramic lens 30, it is to be understood that the camera body may have two or more of such elongations, e.g., the camera body may have two elongated portions located 180° from each other circumferentially around the longitudinal axis A of the panoramic lens 30.

As shown in FIG. 9, the panoramic camera 10 has a total height H_{T} measured along the longitudinal axis A of the lens 30 from the uppermost point of the lens to the bottom surface 16 of the camera body 12. The panoramic lens 30 has an exposed height H_{L} measured along the longitudinal axis A, and the camera body 12 has a body height H_{B} measured along the longitudinal axis A. The sum of the lens height H_{L} and the body height H_{B} equals the total height H_{T} of the panoramic camera 10.

As shown in the longitudinal sectional view of FIG. 8, the camera body 12 has a maximum body thickness T_{M} measured from the top surface 14 to the bottom surface 16 adjacent to the lens support ring 32. As further shown in FIG. 8, the camera body 12 tapers downward and away from the panoramic lens 30, and has a tapered thickness T_{T} measured from the top surface 14 to the bottom surface 16 near the back end 22 of the camera body 12.

In certain embodiments, the maximum body thickness T_{M} is less than 50 percent of either the body width W_{B} or body length L_{B}. The maximum body thickness T_{M} is typically less than 50 percent of both the body width W_{B} and body length L_{B}. For example, the maximum body thickness T_{M} may be from 10 to 60 percent of the body width W_{B}, and from 10 to 40 percent of the body length L_{B}. In certain embodiments, the maximum body thickness T_{M} is from 25 to 50 percent of the body width W_{B}, and from 15 to 30 percent of the body length L_{B}. In certain embodiments, the tapered body thickness T_{T} is from 10 to 60 percent less than the maximum body thickness T_{M}, for example, T_{T} may be from 25 to 50 percent less than T_{M}.

In certain embodiments, the total height H_{T} of the panoramic camera 10 is less than 70 percent of the camera body length L_{B}, for example, H_{T} may be from 10 to 60 percent of L_{B}, or from 20 to 40 percent of L_{B}. In certain embodiments, the total height H_{T} of the panoramic camera 10 is less than 90 percent of the camera body width W_{B}, for example, H_{T} may be from 20 to 80 percent of W_{B}, or from 40 to 60 percent of W_{B}. In certain embodiments, the total height H_{T} of the panoramic camera 10 may be less than 50 mm, for example, less than 35 mm.

In certain embodiments, the camera body height H_{B} is less than 90 percent of the total height H_{T}, for example, H_{B} may be from 50 to 80 percent of H_{T}, or from 60 to 75 percent. In certain embodiments, the exposed lens height H_{L} is at least 10 percent of the camera body height H_{B}, for example, H_{L} may be from 10 to 70 percent of H_{B}, or from 30 to 50 percent of H_{B}.

In accordance with embodiments of the invention, the bottom surface 16 of the camera body 12 has a concave shape. As shown in the longitudinal sectional view of FIG. 8, the bottom surface 16 of the camera body 12 has a concave shape in the longitudinal direction defined by a longitudinal radius of curvature R_{L}. The longitudinal radius of curvature R_{L} may be constant along the longitudinal direction of the camera body 12, or may vary at different locations along the longitudinal direction. For example, the longitudinal radius of the curvature R_{L} may typically range from 100 to 400 mm over at least a portion of the bottom surface, e.g., from 150 to 250 mm. In the embodiment shown in FIG. 8, the longitudinal radius of curvature R_{L} may remain constant along the entire longitudinal length of the bottom surface 16. Alternatively, the shape of the bottom surface 16 along the longitudinal direction may correspond to a complex curve, e.g. having a smaller radius of curvature in the forward region under the lens 30 and a larger radius of curvature in the rearward region under the power button 25.

As shown in the cross-sectional views of FIGS. 9 and 10, the bottom surface 16 of the camera body 12 also has a concave shape along the transverse direction of the camera body. The bottom surface 16 in the region under the lens 30 has a transverse radius of curvature R_{T}, as shown in FIG. 9. The bottom surface 16 in the tapered region under the power button 25 also has a transverse radius of curvature R′_{T}, as shown in FIG. 10. Each of the transverse radiuses of curvature R_{T} and R′_{T} may be the same or different. For example, the transverse radiuses of curvature R_{T} and R′_{T} may typically range from 50 to 300 mm, e.g., from 100 to 200 mm.

In accordance with embodiments of the invention, the concave shape of the bottom surface 16, e.g., as defined by the various radiuses of curvature R_{L}, R_{T} and R′_{T}, is controlled in order to facilitate mounting of the panoramic camera 10 on various portions of a user's body and/or on various apparel or headgear worn by the user. For example, the concave shape of the bottom surface may generally conform to the curvature of a user's head and/or chest, as more fully described below.

As shown in FIGS. 8-10, the top surface 14 of the camera body 12 has a generally conical shape near the panoramic lens 30 that prevents the top surface 14 from entering the field of view FOV in the region near the panoramic lens 30. The regions of the top surface 14 adjacent to the front end 21, left side 23 and right side 24 of the camera body 12 are thus below or outside of the field of view FOV of the lens 30. However, a portion of the top surface 14 adjacent to the back end 22 of the camera body 12 may enter slightly into the field of view FOV of the lens 30. For example, as shown in FIG. 8, the tip of the pyramidal tip of the power button 25 may enter slightly into the field of view FOV′, and/or a small portion of the top surface 14 between the panoramic lens 30 and the power button 25 may enter into the field of view FOV′. Such obstructions may enter into the field of view FOV a distance of from 0° to 5, e.g., from 0.1° to 1° as measured in a plane in which the field of view FOV angle is measured. Furthermore, as measured around the longitudinal axis A of the lens 30, the obstruction may cover an arc of from 0° to 5° circumferentially around the longitudinal axis A, e.g., from 0.1° to 1°. As shown in FIG. 8, the field of view FOV of the lens 30 may thus be partially obstructed in a region where the field of view FOV′ intersects a portion of the top surface 14 near the power button 25. This controlled field of view obstruction FOV′ may be used as a reference point during video capture and/or playback.

As further shown in FIGS. 8 and 9, the panoramic lens 30 is mounted in the camera body 12 through the use of an externally threaded, hollow mounting tube 34. A sensor 40 is positioned below the panoramic lens 30, and an internally threaded mounting ring 42 engages with the mounting tube 34. A sensor board 44 is provided under the sensor 40. The sensor 40 may comprise any suitable type of conventional sensor, such as CMOS or CCD imagers, or the like. For example, the sensor 40 may be a high resolution sensor sold under the designation IMX117 by Sony Corporation. In certain embodiments, video data from certain regions of the sensor 40 may be eliminated prior to transmission, e.g., the corners of a sensor having a square surface area may be eliminated because they do not include useful image data from the circular image produced by the panoramic lens assembly 30, and/or image data from a side portion of a rectangular sensor may be eliminated in a region where the circular panoramic image is not present. In certain embodiments, the sensor 40 may include an on-board or separate encoder. For example, the raw sensor data may be compressed prior to transmission, e.g., using conventional encoders such as jpeg, H.264, H.265, and the like. In certain embodiments, the sensor 40 may support three stream outputs such as: recording H.264 encoded .mp4 (e.g., image size 1504×1504); RTSP stream (e.g., image size 750×750); and snapshot (e.g., image size 1504×1504). However, any other desired number of image streams, and any other desired image size for each image stream, may be used.

A tiling and de-tiling process may be used in accordance with the present invention. Tiling is a process of chopping up a circular image of the sensor 40 produced from the panoramic lens 30 into pre-defined chunks to optimize the image for encoding and decoding for display without loss of image quality, e.g., as a 1080p image on certain mobile platforms and common displays. The tiling process may provide a robust, repeatable method to make panoramic video universally compatible with display technology while maintaining high video image quality. Tiling may be used on any or all of the image streams, such as the three stream outputs described above. The tiling may be done after the raw video is presented, then the file may be encoded with an industry standard H.264 encoding or the like. The encoded streams can then be decoded by an industry standard decoder and the user side. The image may be decoded and then de-tiled before presentation to the user. The de-tiling can be optimized during the presentation process depending on the display that is being used as the output display. The tiling and de-tiling process may preserve high quality panoramic images and optimize resolution, while minimizing processing required on both the camera side and on the user side for lowest possible battery consumption and low latency. The image may be dewarped through the use of dewarping software or firmware after the de-tiling reassembles the image. The dewarped image may be manipulated by an app, as more fully described below.

As further shown in FIGS. 8 and 9, an internal support base 50 is provided inside the camera body 12. In addition to supporting the lens 30 and sensor 40, the internal support base 50 supports a processor board 60. A heat shield plate 62 is provided between the processor board 60 and the sensor 40. The processor board 60 may function as the command and control center of the camera system 10 to control the video processing, data storage and wireless or other communication command and control. Video processing may comprise encoding video using industry standard H.264 profiles or the like to provide natural image flow with a standard file format. Decoding video for editing purposes may also be performed. Data storage may be accomplished by writing data files to an SD memory card or the like, and maintaining a library system. Data files may be read from the SD card for preview and transmission. Wireless command and control may be provided. For example, Bluetooth commands may include processing and directing actions of the camera received from a Bluetooth radio and sending responses to the Bluetooth radio for transmission to the camera. WIFI radio may also be used for transmitting and receiving data and video. Such Bluetooth and WIFI functions may be performed with a single processor board 60 as shown in the figures, or with separate boards. Cellular communication may also be provided, e.g., with a separate board, or in combination with any of the boards described above.

As shown most clearly in FIGS. 8 and 10, the panoramic camera 10 includes a battery 80 located toward the back end 22 of the camera body 12. As shown most clearly in FIG. 8, the battery 80 is angled down and away from the lens 30 within the camera body 12. In the embodiment shown, the angle of the battery 80 is about 25° as measured from a plane perpendicular to the longitudinal axis A of the lens 30. In certain embodiments, the battery angle may range from 5° to 45°, or from 10° to 40°, or from 15° to 35°, or from 20° to 30°. As shown in FIG. 8, substantially all of the battery 80 is offset rearwardly from the lens 30.

As further shown in FIG. 8, the microphone hole 28 extending through the top surface 14 of the camera body 12 communicates with a microphone 29 that is adjacent to, and powered by, the battery 80. The power button 25 is also adjacent to the battery 80. Any suitable type of microphone 29 may be provided inside the camera body 12 near the microphone hole 28 to detect sound. One or more microphones may be used inside and/or outside the camera body 12. In addition to an internal microphone(s), at least one microphone may be mounted on the camera system 10 and/or positioned remotely from the system. In the event that multiple channels of audio data are recorded from a plurality of microphones in a known orientation, the audio field may be rotated during playback to synchronize spatially with the interactive renderer display. The microphone output may be stored in an audio buffer and compressed before being recorded. In the event that multiple channels of audio data are recorded from a plurality of microphones in a known orientation, the audio field may be rotated during playback to synchronize spatially with the corresponding portion of the video image.

In certain embodiments, a wife board and/or Bluetooth board may be provided inside the camera body 12. It is understood that the functions of such boards may be combined onto a single board, e.g., onto the processor module 60. Furthermore, additional functions may be added to such board(s) such as cellular communication and motion sensor functions. A vibration motor may also be included.

In accordance with embodiments of the present invention, at least one motion sensor, such as an accelerometer, gyroscope, compass, barometer and/or GPS sensor, may be located within the camera body 12. For example, the panoramic camera system 10 may include one or more motion sensors, e.g., as part of the processor module 60. As used herein, the term “motion sensor” includes sensors that can detect motion, orientation, position and/or location, including linear motion and/or acceleration, rotational motion and/or acceleration, orientation of the camera system (e.g., pitch, yaw, tilt), geographic position, gravity vector, altitude, height, and the like. For example, the motion sensor(s) may include accelerometers, gyroscopes, global positioning system (GPS) sensors, barometers and/or compasses that produce data simultaneously with the optical and, optionally, audio data. Such motion sensors can be used to provide the motion, orientation, position and location information used to perform some of the image processing and display functions described herein. This data may be encoded and recorded. The captured motion sensor data may be synchronized with the panoramic visual images captured by the camera system 10, and may be associated with a particular image view corresponding to a portion of the panoramic visual images, for example, as described in U.S. Pat. Nos. 8,730,322, 8,836,783 and 9,204,042.

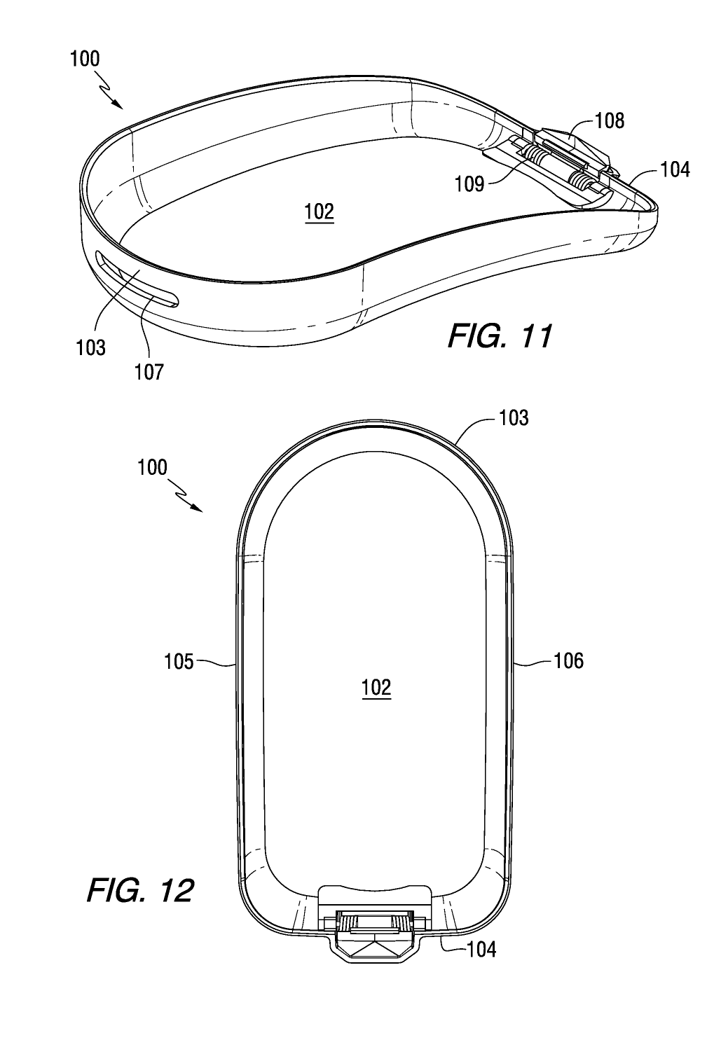

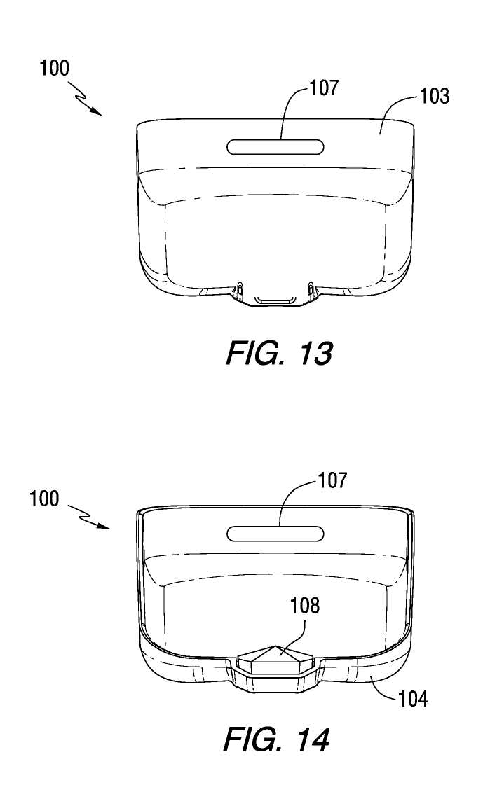

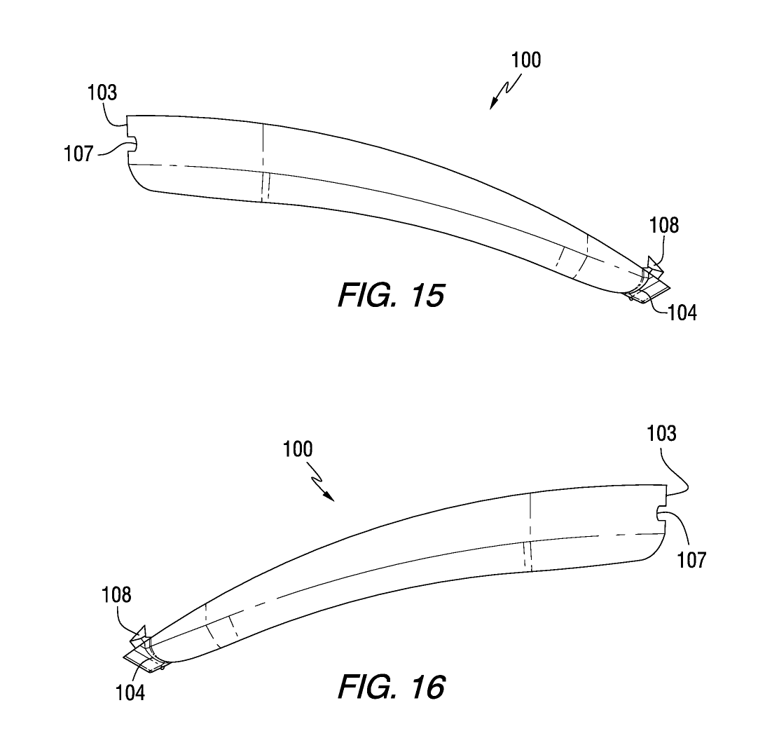

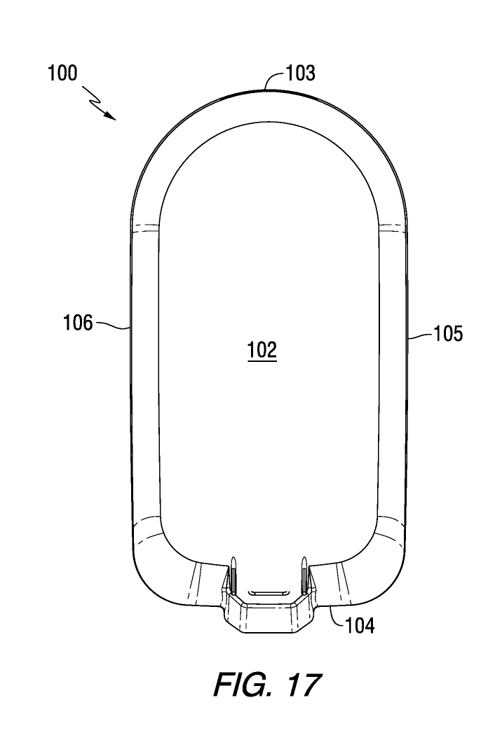

FIGS. 11-17 illustrate a mounting base 100 that may be used to secure the panoramic camera 10 in accordance with embodiments of the present invention. The mounting base 100 includes a bottom 102, front 103, back 104, left side 105, and right side 106. A retaining slot 105 is provided through the front end 103 of the mounting base 100. A retaining clip 108 is provided near the back end 104 of the mounting base 100. The retaining clip 108 is biased by a spring 109 for engaging the retaining lip 27 of the camera body 12. When the panoramic camera 10 is mounted in the mounting base 100, the retaining tab 26 of the camera body 12 is inserted into the retaining slot 107 of the mounting base 100. The retaining clip 108 of the mounting base 100 contacts the retaining lip 27 of the camera body 12. The retaining clip 108 may be pressed and rotated against the bias of the spring 109 in order to remove the panoramic camera 10 from the mounting base 100. To install the panoramic camera 10, the retaining tab 26 is inserted in the retaining slot 107 of the mounting base 100, and the back end 22 of the camera body 12 may be pressed toward the bottom 102 of the mounting base 100. Such a pressing motion forces the retaining clip 108 into an open position until the bottom surface 16 of the camera body 12 is seated against the bottom 102 of the mounting base 100.

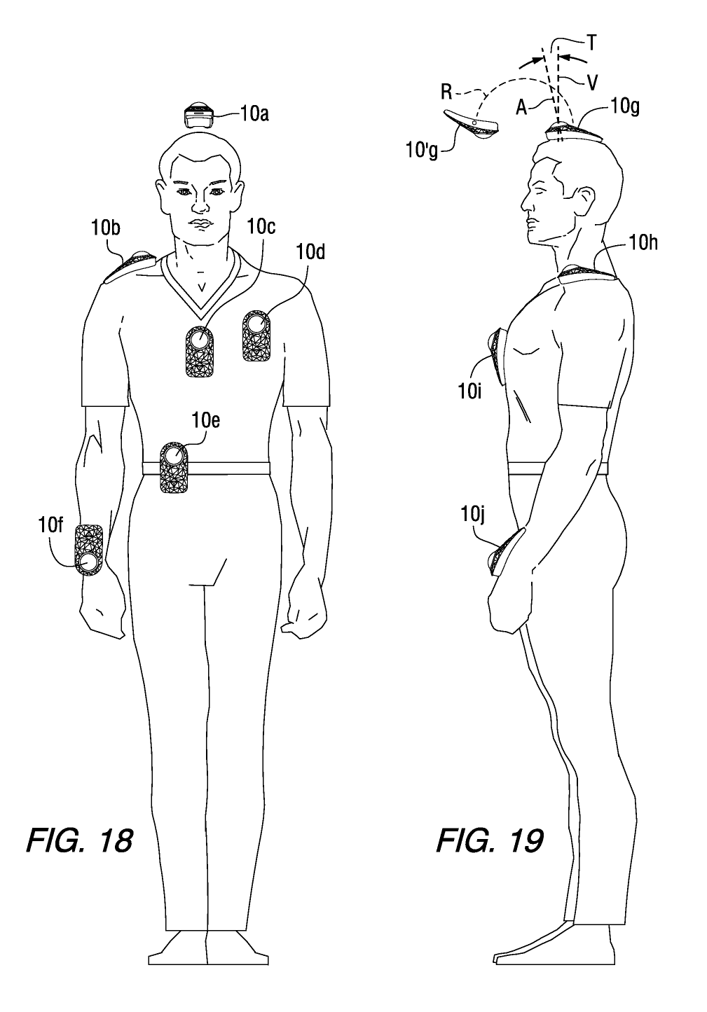

FIGS. 18 and 19 schematically illustrate a panoramic camera as described herein mounted at various locations in relation to a user's body. In FIG. 18, the panoramic camera is shown: above the user's head 10a; on the user's shoulder 10b; in the center of the user's chest 10c; on the side of the user's chest 10d; on the user's belt 10e, and on the user's wrist 10f. In FIG. 19, the panoramic camera is shown: on the user's head 10g; on the user's shoulder 10h; on the user's chest 10i; and on the user's wrist 10j. As shown in FIG. 19, the panoramic camera 10g may be flipped, pivoted along a rotational path R, or extended by any suitable mounting bracket or device, from a position above the user's head 10g to an extended position 10g in which the user's face will be within the field of view of the panoramic camera 10g. Similar pivoting/extension movements may be used when the panoramic camera is positioned at other locations on the user, utilizing any suitable mounting brackets or devices that would be apparent to those skilled in the art.

The panoramic cameras of the present invention may be positioned at any other location with respect to the user, beyond the locations shown in FIGS. 18 and 19. Furthermore, when the panoramic camera is positioned at a specific location, the orientation of the panoramic camera may be adjusted as desired. For example, while the head-mounted cameras 10a and 10g shown in FIGS. 18 and 19 are oriented in a “forward facing” position with the front end forward, the rear end backward, and the bottom surface on or adjacent to the user's head, the cameras could be turned to any desired position, e.g., 90°, 180°, etc. with the bottom surface remaining on or adjacent to the user's head. Similarly, any of the body-mounted cameras could be rotated, e.g., 90°, 180°, etc. with the bottom surface remaining on or adjacent to the user's body. Any suitable means of attachment to the user's body, clothing, headgear, etc. may be used, such as clips, mechanical fasteners, magnets, hook-and-loop fasteners, straps, adhesives, and the like. For head-mounted uses, any suitable structure may be used to support the camera, e.g., helmets, caps, head bands, and the like. For example, the camera may be mounted on or in various types of sports helmets, recreational helmets, cycling helmets, protective helmets, baseball caps, and the like (not shown). In addition, the panoramic camera 10 may be mounted on any other support structure such as mounting brackets and adaptors, and may be used in vehicles, aircraft, drones, watercraft and the like, e.g., as a dash-mounted or window-mounted panoramic camera in a motor vehicle, etc.

In certain embodiments, the orientation of the longitudinal axis A of the panoramic lens 30 may be controlled when the panoramic camera 10 is mounted on a helmet, apparel, or other support structure or bracket. For example, when the panoramic camera 10 is mounted on a helmet, the orientation of the panoramic camera 10 in relation to the helmet may be controlled to provide a desired tilt angle when the wearer's head is in a typical position during use of the camera, such as when a motorcyclist or bicyclist is riding, a skier is skiing, a snowboarder is snowboarding, a hockey player is skating, etc. An example of such tilt angle control is schematically illustrated in FIG. 19, in which the panoramic camera 10g is oriented in relation to the user's head such that the longitudinal axis A is tilted from the vertical direction V at a tilt angle T when the user's head is in a particular position. In certain embodiments, the tilt angle T may range from +90° to −90°, or from +45° to −45°, or from +30° to −30°, or from +20° to −20°, or from +10° to −10°. For example, as shown in FIG. 19, the tilt angle T may be forward facing, and may range from 0° to 90° or more, e.g., from 1° to 30°, or from 2° to 20°, or from 3° to 15°, or from 5° to 10°.

In accordance with embodiments of the invention, the orientation of the panoramic camera 10 and its field of view may be key elements to capture certain portions of an experience such as riding a bicycle or motorcycle, skiing, snowboarding, surfing, etc. For example, the camera may be moved toward the front of the user's head to capture the steering wheel of a bicycle or motorcycle, while at the same capturing the back view of the riding experience. From the user's perspective in relationship to a horizon line, the camera can be oriented slightly forward, e.g., with its longitudinal axis A tilted forward at from 5° to 10° or more, as described above.

When the panoramic camera is equipped with a motion sensor(s), various types of motion data may be captured and used. For example, orientation based tilt can be derived from accelerometer data. This can be accomplished by computing the live gravity vector relative to the camera system 10. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the device vertically may center the view on the horizon), or it may be used with an arbitrary offset for the convenience of the operator. This offset may be determined based on the initial orientation of the device when playback begins (e.g., the angular position of the device when playback is started can be centered on the horizon).

Any suitable accelerometer may be used, such as conventional 3-axis and 9-axis accelerometers. For example, a 3 axis BMA250 accelerometer from BOSCH or the like may be used. A 3-axis accelerometer may enhance the capability of the camera to determine its orientation in 3D space using an appropriate algorithm. The camera system 10 may capture and embed the raw accelerometer data into the metadata path in a MPEG4 transport stream, providing the full capability of the information from the accelerometer that provides the user side with details to orient the image to the horizon.

The motion sensor may comprise a GPS sensor capable of receiving satellite transmissions, e.g., the system can retrieve position information from GPS data. Absolute yaw orientation can be retrieved from compass data, acceleration due to gravity may be determined through a 3-axis accelerometer when the computing device is at rest, and changes in pitch, roll and yaw can be determined from gyroscope data. Velocity can be determined from GPS coordinates and timestamps from the software platform's clock. Finer precision values can be achieved by incorporating the results of integrating acceleration data over time. The motion sensor data can be further combined using a fusion method that blends only the required elements of the motion sensor data into a single metadata stream or in future multiple metadata streams.

The motion sensor may comprise a gyroscope which measures changes in rotation along multiple axes over time, and can be integrated over time intervals, e.g., between the previous rendered frame and the current frame. For example, the total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset. Automatic roll correction can be computed as the angle between the device's vertical display axis and the gravity vector from the device's accelerometer.

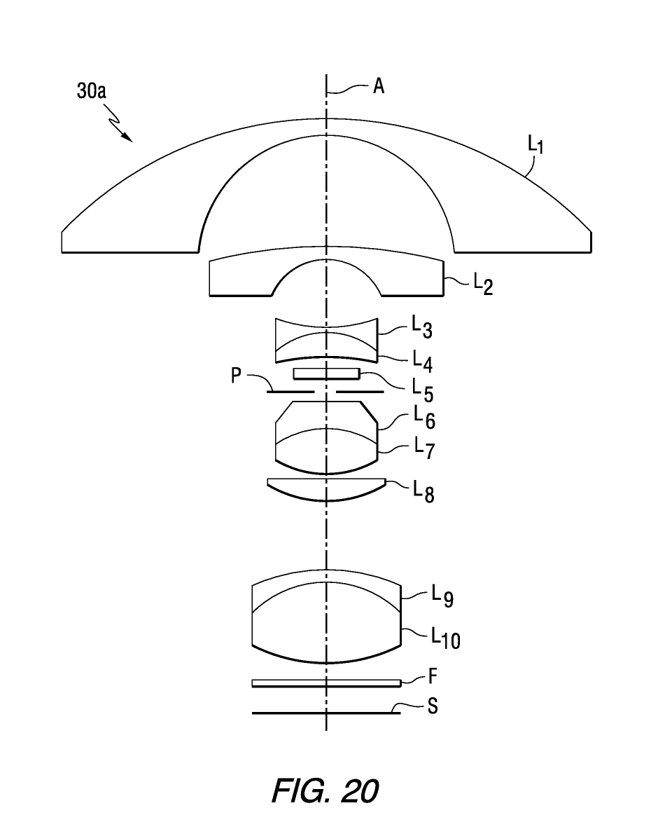

In accordance with embodiments of the present invention, the panoramic lenses 30 and 130 may comprise transmissive hyper-fisheye lenses with multiple transmissive elements (e.g., dioptric systems); reflective mirror systems (e.g., panoramic mirrors as disclosed in U.S. Pat. Nos. 6,856,472; 7,058,239; and 7,123,777, which are incorporated herein by reference); or catadioptric systems comprising combinations of transmissive lens(es) and mirror(s). In certain embodiments, the panoramic lens 30 comprises various types of transmissive dioptric hyper-fisheye lenses. Such lenses may have fields of view FOVs as described above, and may be designed with suitable F-stop speeds. F-stop speeds may typically range from f/1 to f/8, for example, from f/1.2 to f/3. As a particular example, the F-stop speed may be about f/2.5. Examples of panoramic lenses are schematically illustrated in FIGS. 20-23.

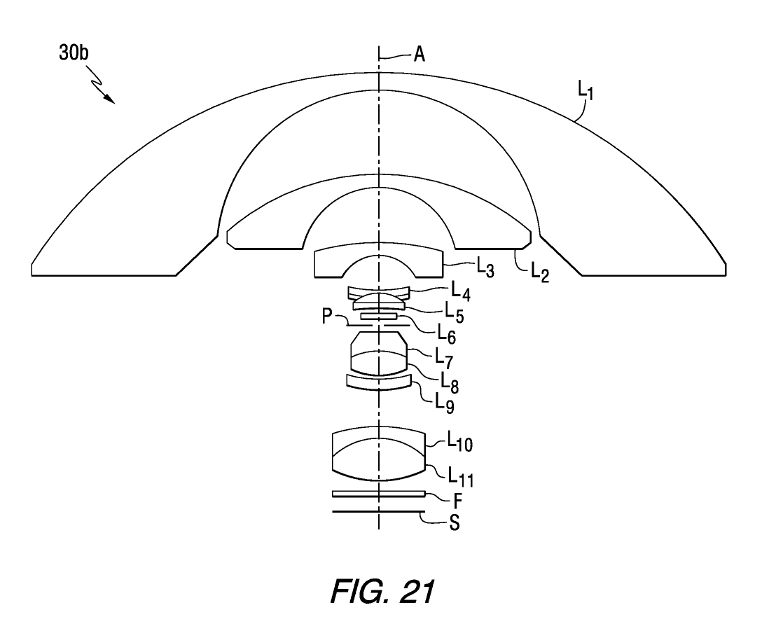

FIGS. 20 and 21 schematically illustrate panoramic lens systems 30a and 30b similar to those disclosed in U.S. Pat. No. 3,524,697, which is incorporated herein by reference. The panoramic lens 30a shown in FIG. 20 has a longitudinal axis A and comprises ten lens elements L₁-L₁₀. In addition, the panoramic lens system 30a includes a plate P with a central aperture, and may be used with a filter F and sensor S. The filter F may comprises any conventional filter(s), such as infrared (IR) filters and the like. The panoramic lens system 30b shown in FIG. 21 has a longitudinal axis A and comprises eleven lens elements L₁-L₁₁. In addition, the panoramic lens system 30b includes a plate P with a central aperture, and is used in conjunction with a filter F and sensor S.

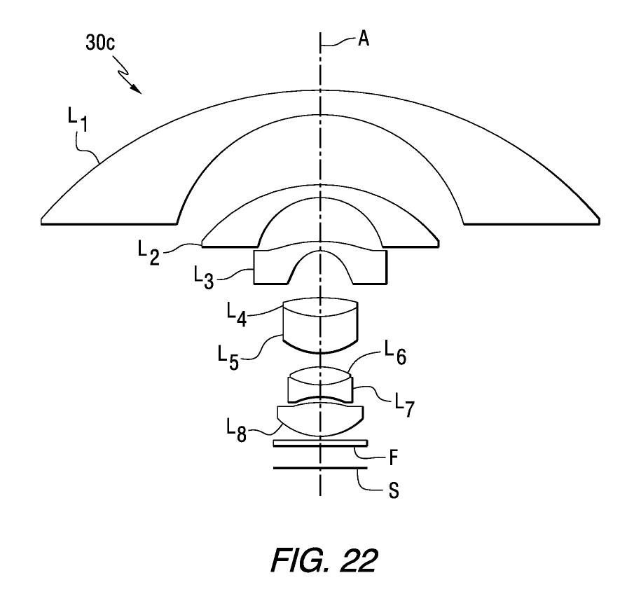

In the embodiment shown in FIG. 22, the panoramic lens assembly 30c has a longitudinal axis A and includes eight lens elements L₁-L₈. In addition, a filter F and sensor S may be used in conjunction with the panoramic lens assembly 30c.

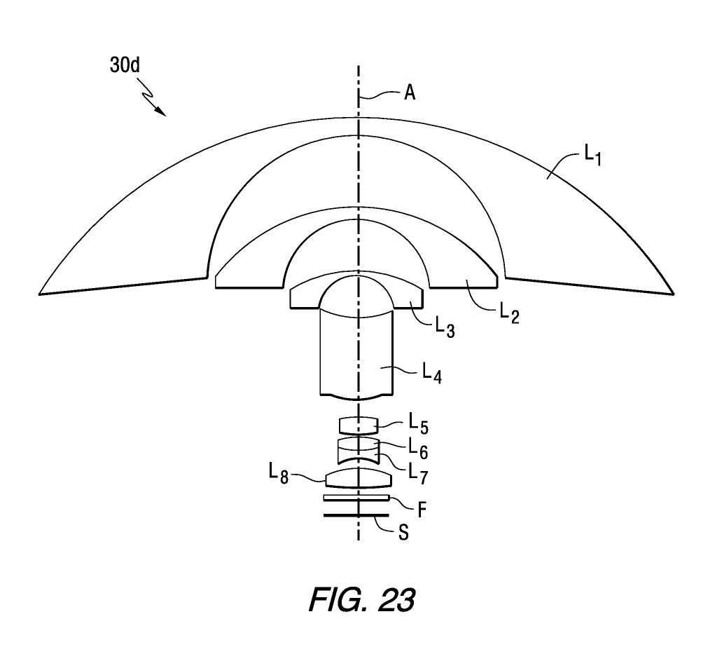

In the embodiment shown in FIG. 23, the panoramic lens assembly 30d has a longitudinal axis A and includes eight lens elements L₁-L₈. In addition, a filter F and sensor S may be used in conjunction with the panoramic lens assembly 30d.

In each of the panoramic lens assemblies 30a-30d shown in FIGS. 20-23, as well as any other type of panoramic lens assembly that may be selected for use in the first panoramic camera module 20, the number and shapes of the individual lens elements L may be routinely selected by those skilled in the art. Furthermore, the lens elements L may be made from conventional lens materials such as glass and plastics known to those skilled in the art.

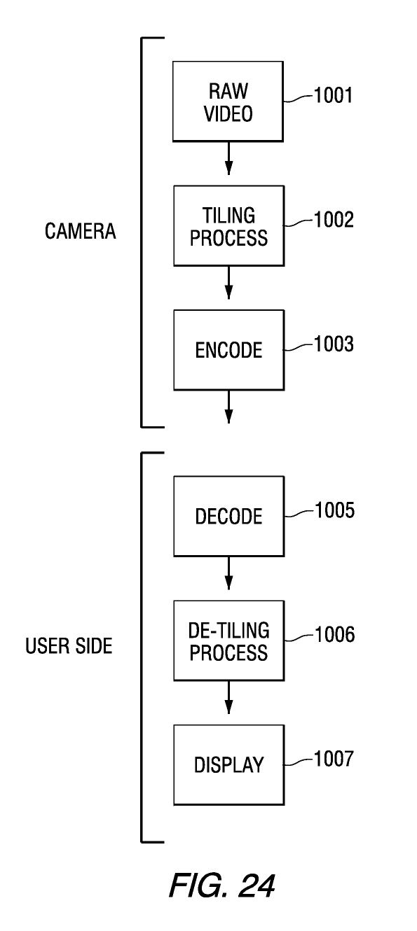

FIG. 24 illustrates an example of processing video or other audiovisual content captured by a device such as various embodiments of camera systems described herein. Various processing steps described herein may be executed by one or more algorithms or image analysis processes embodied in software, hardware, firmware, or other suitable computer-executable instructions, as well as a variety of programmable appliances or devices. As shown in FIG. 24, from the device perspective, raw video content can be captured at processing step 1001 by a user employing the modular camera system 10, for example. At step 1002, the video content can be tiled, or otherwise subdivided into suitable segments or sub-segments, for encoding at step 1003. The encoding process may include a suitable compression technique or algorithm and/or may be part of a codec process such as one employed in accordance with the H.264 or H.265 video formats, for example, or other similar video compression and decompression standards. From the user perspective, at step 1005 the encoded video content may be communicated to a user device, appliance, or video player, for example, where it is decoded or decompressed for further processing. At step 1006, the decoded video content may be de-tiled and/or stitched together for display at step 1007. In various embodiments, the display may be part of a smart phone, a computer, video editor, video player, and/or another device capable of displaying the video content to the user.

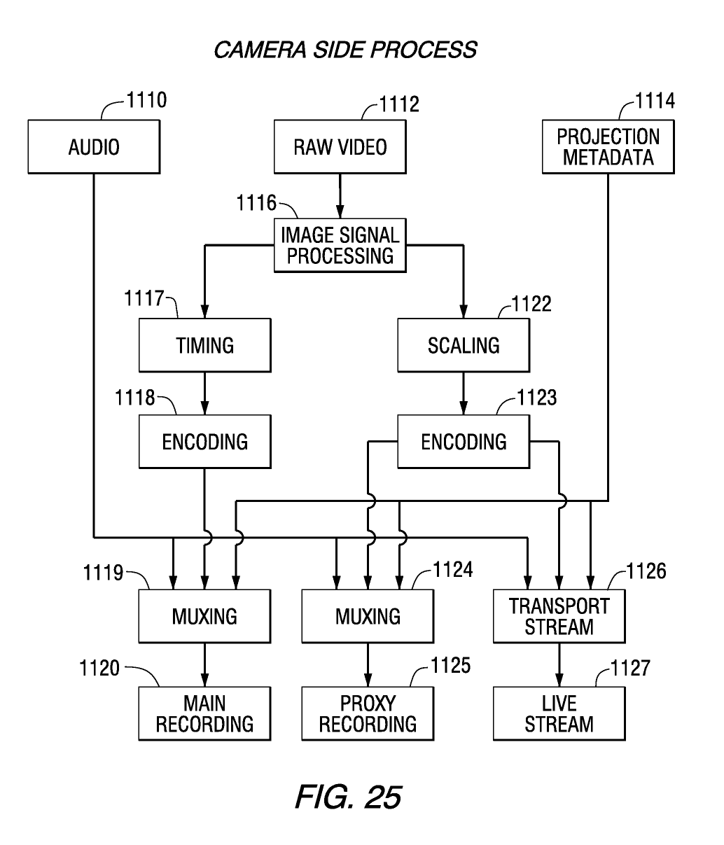

FIG. 25 illustrates various examples from the camera perspective of processing video, audio, and metadata content captured by a device which can be structured in accordance with various embodiments of cameras described herein. At step 1110, an audio signal associated with captured content may be processed which is representative of noise, music, or other audible events captured in the vicinity of the camera. At step 1112, raw video associated with video content may be collected representing graphical or visual elements captured by the camera device. At step 1114, projection metadata may be collected which comprise motion detection data, for example, or other data which describe the characteristics of the spatial reference system used to geo-reference a video data set to the environment in which the video content was captured. At step 1116, image signal processing of the raw video content (obtained from step 1112) may be performed by applying a timing process to the video content at step 1117, such as to determine and synchronize a frequency for image data presentation or display, and then encoding the image data at step 1118. In certain embodiments, image signal processing of the raw video content (obtained from step 1112) may be performed by scaling certain portions of the content at step 1122, such as by a transformation involving altering one or more of the size dimensions of a portion of image data, and then encoding the image data at step 1123.

At step 1119, the audio data signal from step 1110, the encoded image data from step 1118, and the projection metadata from step 1114 may be multiplexed into a single data file or stream as part of generating a main recording of the captured video content at step 1120. In other embodiments, the audio data signal from step 1110, the encoded image data from step 1123, and the projection metadata from step 1114 may be multiplexed at step 1124 into a single data file or stream as part of generating a proxy recording of the captured video content at step 1125. In certain embodiments, the audio data signal from step 1110, the encoded image data from step 1123, and the projection metadata from step 1114 may be combined into a transport stream at step 1126 as part of generating a live stream of the captured video content at step 1127. It can be appreciated that each of the main recording, proxy recording, and live stream may be generated in association with different processing rates, compression techniques, degrees of quality, or other factors which may depend on a use or application intended for the processed content.

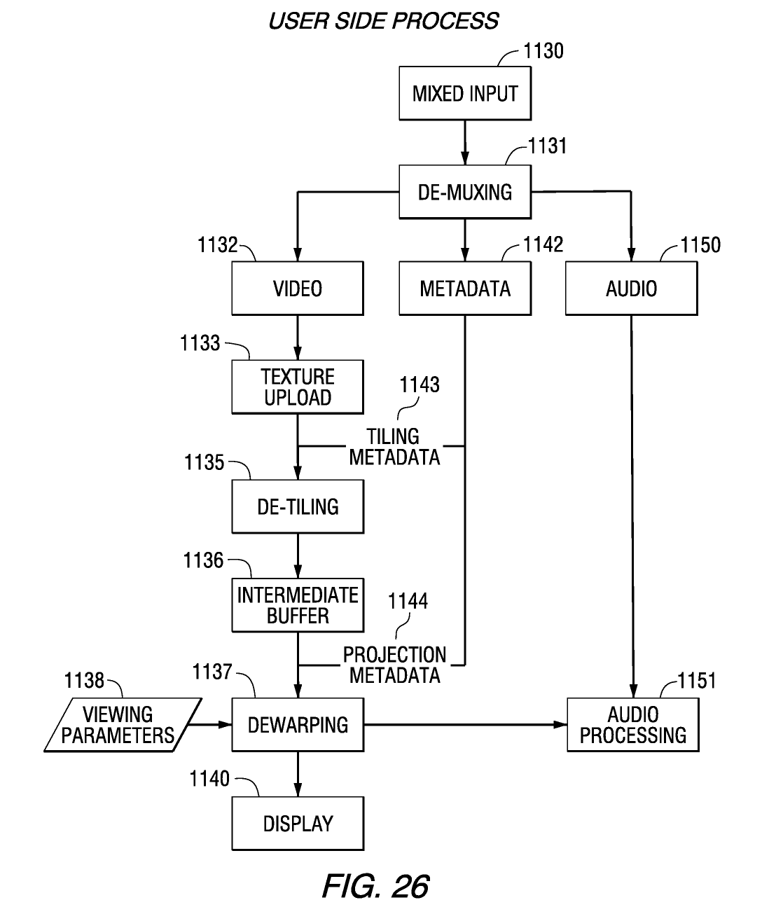

FIG. 26 illustrates various examples from the user perspective of processing video data or image data processed by and/or received from a camera device. Multiplexed input data received at step 1130 may be demultiplexed or de-muxed at step 1131. The demultiplexed input data may be separated into its constituent components including video data at step 1132, metadata at step 1142, and audio data at step 1150. A texture upload process may be applied in association with the video data at step 1133 to incorporate data representing the surfaces of various objects displayed in the video data, for example. At step 1143, tiling metadata (as part of the metadata of step 1142) may be processed with the video data, such as in conjunction with executing a de-tiling process at step 1135, for example. At step 1136, an intermediate buffer may be employed to enhance processing efficiency for the video data. At step 1144, projection metadata (as part of the metadata of step 1142) may be processed along with the video data prior to dewarping the video data at step 1137. Dewarping the video data may involve addressing optical distortions by remapping portions of image data to optimize the image data for an intended application. Dewarping the video data may also involve processing one or more viewing parameters at step 1138, which may be specified by the user based on a desired display appearance or other characteristic of the video data, and/or receiving audio data processed at step 1151. The processed video data may then be displayed at step 1140 on a smart phone, a computer, video editor, video player, virtual reality headset and/or another device capable of displaying the video content.

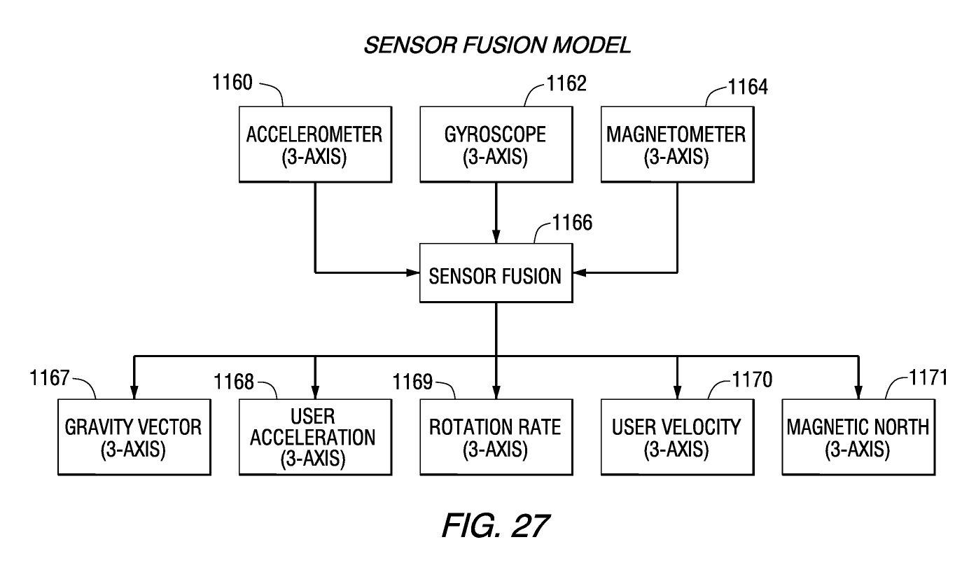

FIG. 27 depicts an example of a sensor fusion model which can be employed in connection with various embodiments of the devices and processes described herein. As shown, a sensor fusion process 1166 receives input data from one or more of an accelerometer 1160, a gyroscope 1162, or a magnetometer 1164, each of which may be a three-axis sensor device, for example. Those skilled in the art can appreciate that multi-axis accelerometers 1160 can be configured to detect magnitude and direction of acceleration as a vector quantity, and can be used to sense orientation (e.g., due to direction of weight changes). The gyroscope 1162 can be used for measuring or maintaining orientation, for example. The magnetometer 1164 may be used to measure the vector components or magnitude of a magnetic field, wherein the vector components of the field may be expressed in terms of declination (e.g., the angle between the horizontal component of the field vector and magnetic north) and the inclination (e.g., the angle between the field vector and the horizontal surface). With the collaboration or fusion of these various sensors 1160, 1162, 1164, one or more of the following data elements can be determined during operation of the camera device: gravity vector 1167, user acceleration 1168, rotation rate 1169, user velocity 1170, and/or magnetic north 1171.

The images from the camera system 10 may be displayed in any suitable manner. For example, a touch screen may be provided to sense touch actions provided by a user. User touch actions and sensor data may be used to select a particular viewing direction, which is then rendered. The device can interactively render the texture mapped video data in combination with the user touch actions and/or the sensor data to produce video for display. The signal processing can be performed by a processor or processing circuitry.

Video images from the camera system 10 may be downloaded to various display devices, such as a smart phone using an app, or any other current or future display device. Many current mobile computing devices, such as the iPhone, contain built-in touch screen or touch screen input sensors that can be used to receive user commands. In usage scenarios where a software platform does not contain a built-in touch or touch screen sensor, externally connected input devices can be used. User input such as touching, dragging, and pinching can be detected as touch actions by touch and touch screen sensors though the usage of off the shelf software frameworks.

User input, in the form of touch actions, can be provided to the software application by hardware abstraction frameworks on the software platform. These touch actions enable the software application to provide the user with an interactive presentation of prerecorded media, shared media downloaded or streamed from the internet, or media which is currently being recorded or previewed.

An interactive renderer may combine user input (touch actions), still or motion image data from the camera (via a texture map), and movement data (encoded from geospatial/orientation data) to provide a user controlled view of prerecorded media, shared media downloaded or streamed over a network, or media currently being recorded or previewed. User input can be used in real time to determine the view orientation and zoom. As used in this description, real time means that the display shows images at essentially the same time the images are being sensed by the device (or at a delay that is not obvious to a user) and/or the display shows images changes in response to user input at essentially the same time as the user input is received. By combining the panoramic camera with a mobile computing device, the internal signal processing bandwidth can be sufficient to achieve the real time display.

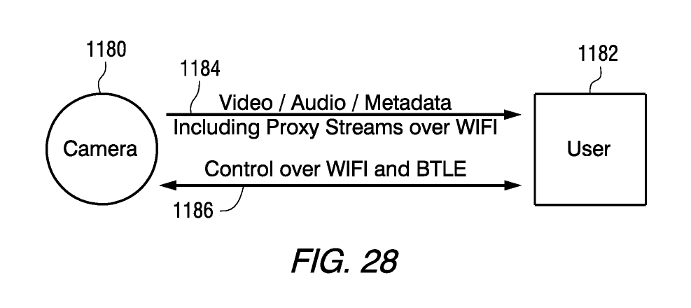

FIG. 28 illustrates an example interaction between a camera device 1180 and a user 1182 of the camera 1180. As shown, the user 1182 may receive and process video, audio, and metadata associated with captured video content with a smart phone, computer, video editor, video player, virtual reality headset and/or another device. As described above, the received data may include a proxy stream which enables subsequent processing or manipulation of the captured content subject to a desired end use or application. In certain embodiments, data may be communicated through a wireless connection (e.g., a Wi-Fi or cellular connection) from the camera 1180 to a device of the user 1182, and the user 1182 may exercise control over the camera 1180 through a wireless connection (e.g., Wi-Fi or cellular) or near-field communication (e.g., Bluetooth).

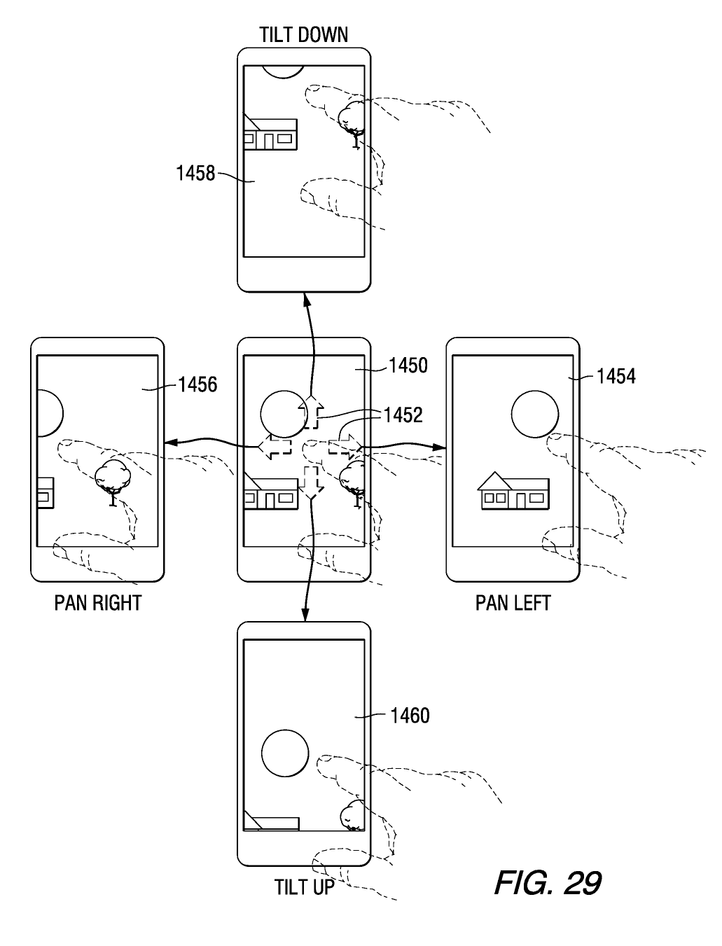

FIG. 29 illustrates pan and tilt functions in response to user commands. The mobile computing device includes a touch screen display 1450. A user can touch the screen and move in the directions shown by arrows 1452 to change the displayed image to achieve pan and/or tile function. In screen 1454, the image is changed as if the camera field of view is panned to the left. In screen 1456, the image is changed as if the camera field of view is panned to the right. In screen 1458, the image is changed as if the camera is tilted down. In screen 1460, the image is changed as if the camera is tilted up. As shown in FIG. 29, touch based pan and tilt allows the user to change the viewing region by following single contact drag. The initial point of contact from the user's touch is mapped to a pan/tilt coordinate, and pan/tilt adjustments are computed during dragging to keep that pan/tilt coordinate under the user's finger.

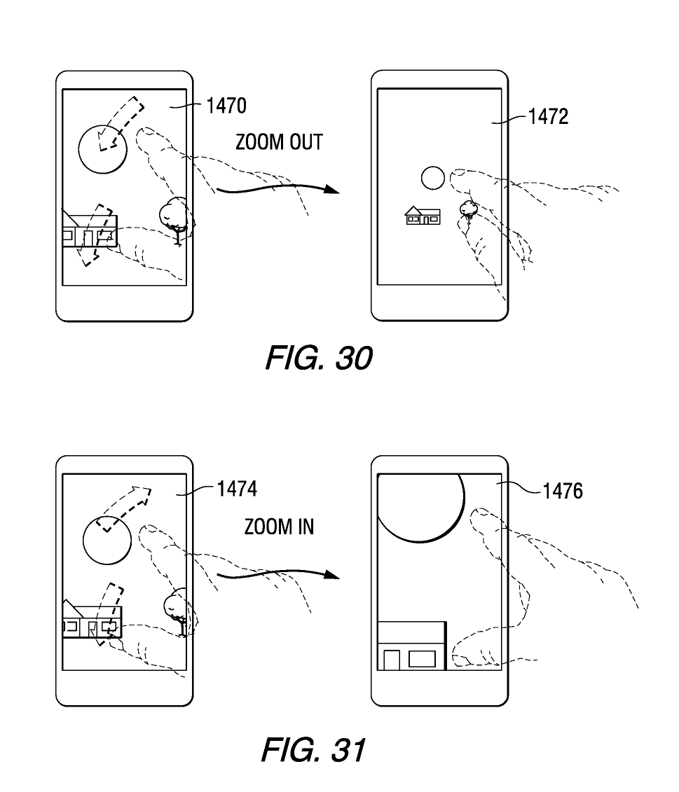

As shown in FIGS. 30 and 31, touch based zoom allows the user to dynamically zoom out or in. Two points of contact from a user touch are mapped to pan/tilt coordinates, from which an angle measure is computed to represent the angle between the two contacting fingers. The viewing field of view (simulating zoom) is adjusted as the user pinches in or out to match the dynamically changing finger positions to the initial angle measure. As shown in FIG. 30, pinching in the two contacting fingers produces a zoom out effect. That is, object in screen 1470 appear smaller in screen 1472. As shown in FIG. 31, pinching out produces a zoom in effect. That is, object in screen 1474 appear larger in screen 1476.

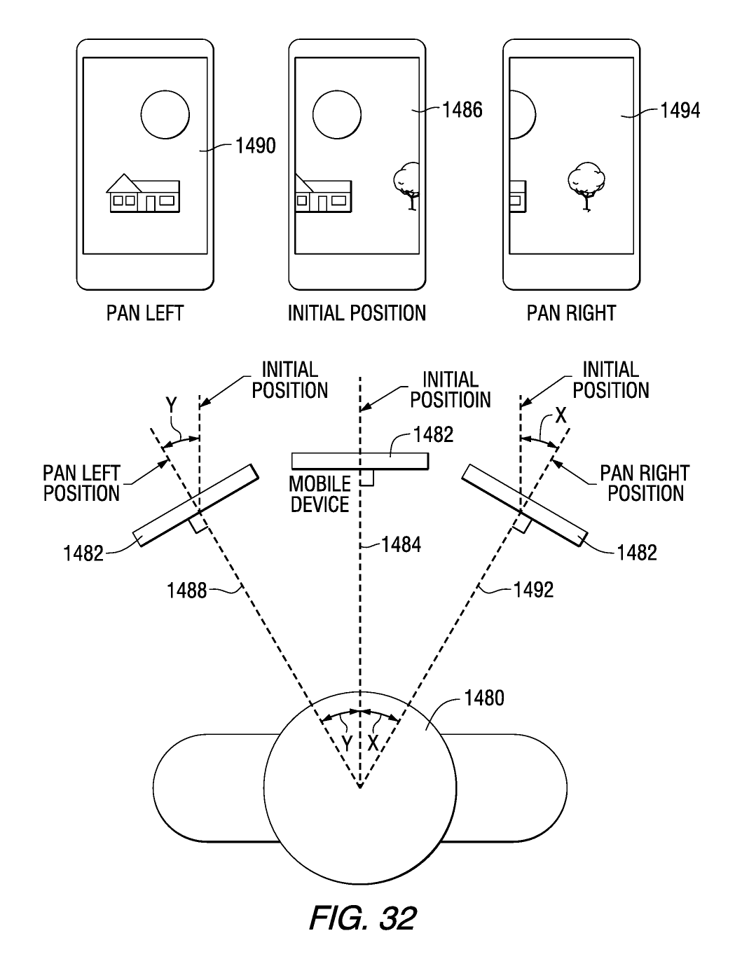

FIG. 32 illustrates an orientation based pan that can be derived from compass data provided by a compass sensor in the computing device, allowing the user to change the displaying pan range by turning the mobile device. This can be accomplished by matching live compass data to recorded compass data in cases where recorded compass data is available. In cases where recorded compass data is not available, an arbitrary north value can be mapped onto the recorded media. When a user 1480 holds the mobile computing device 1482 in an initial position along line 1484, the image 1486 is produced on the device display. When a user 1480 moves the mobile computing device 1482 in a pan left position along line 1488, which is offset from the initial position by an angle y, the image 1490 is produced on the device display. When a user 1480 moves the mobile computing device 1482 in a pan right position along line 1492, which is offset from the initial position by an angle x, the image 1494 is produced on the device display. In effect, the display is showing a different portion of the panoramic image capture by the combination of the camera and the panoramic optical device. The portion of the image to be shown is determined by the change in compass orientation data with respect to the initial position compass data.

Sometimes it is desirable to use an arbitrary north value even when recorded compass data is available. It is also sometimes desirable not to have the pan angle change 1:1 with the device. In some embodiments, the rendered pan angle may change at user-selectable ratio relative to the device. For example, if a user chooses 4x motion controls, then rotating the display device thru 90° will allow the user to see a full rotation of the video, which is convenient when the user does not have the freedom of movement to spin around completely.

In cases where touch based input is combined with an orientation input, the touch input can be added to the orientation input as an additional offset. By doing so conflict between the two input methods is avoided effectively.

On mobile devices where gyroscope data is available and offers better performance, gyroscope data which measures changes in rotation along multiple axes over time, can be integrated over the time interval between the previous rendered frame and the current frame. This total change in orientation can be added to the orientation used to render the previous frame to determine the new orientation used to render the current frame. In cases where both gyroscope and compass data are available, gyroscope data can be synchronized to compass positions periodically or as a one-time initial offset.

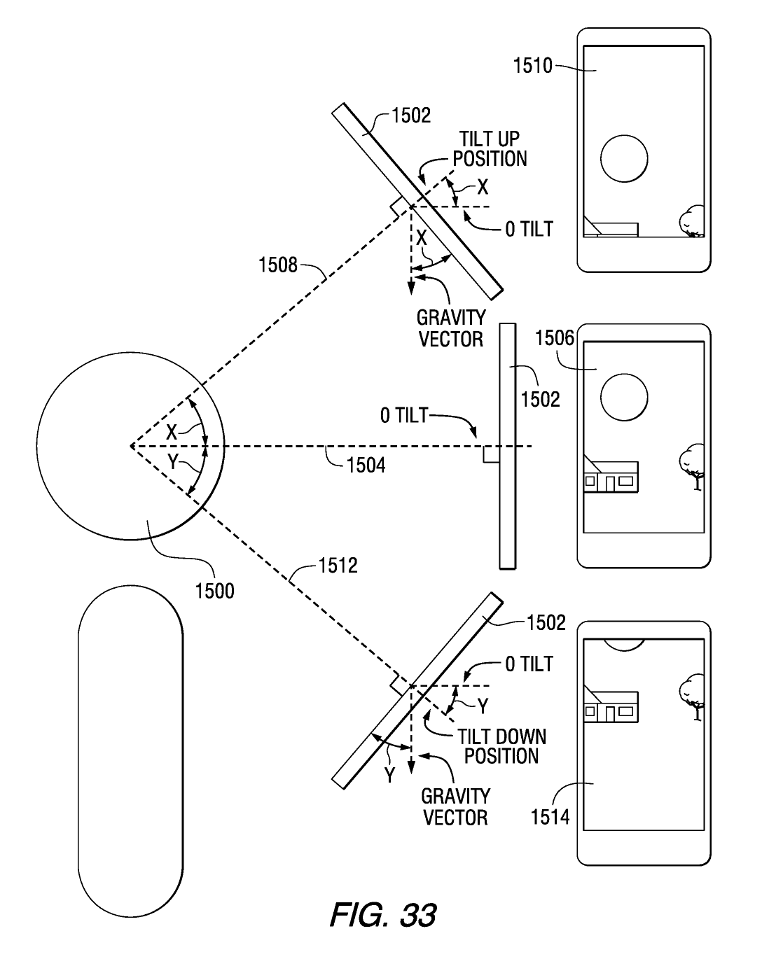

As shown in FIG. 33, orientation based tilt can be derived from accelerometer data, allowing the user to change the displaying tilt range by tilting the mobile device. This can be accomplished by computing the live gravity vector relative to the mobile device. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the phone vertically will center the view on the horizon), or it may be used with an arbitrary offset for the convenience of the operator. This offset may be determined based on the initial orientation of the device when playback begins (e.g. the angular position of the phone when playback is started can be centered on the horizon). When a user 1500 holds the mobile computing device 1502 in an initial position along line 1504, the image 1506 is produce on the device display. When a user 1500 moves the mobile computing device 1502 in a tilt up position along line 1508, which is offset from the gravity vector by an angle x, the image 1510 is produce on the device display. When a user 1500 moves the mobile computing device 1502 in a tilt down position along line 1512, which is offset from the gravity by an angle y, the image 1514 is produce on the device display. In effect, the display is showing a different portion of the panoramic image captured by the combination of the camera and the panoramic optical device. The portion of the image to be shown is determined by the change in vertical orientation data with respect to the initial position compass data.

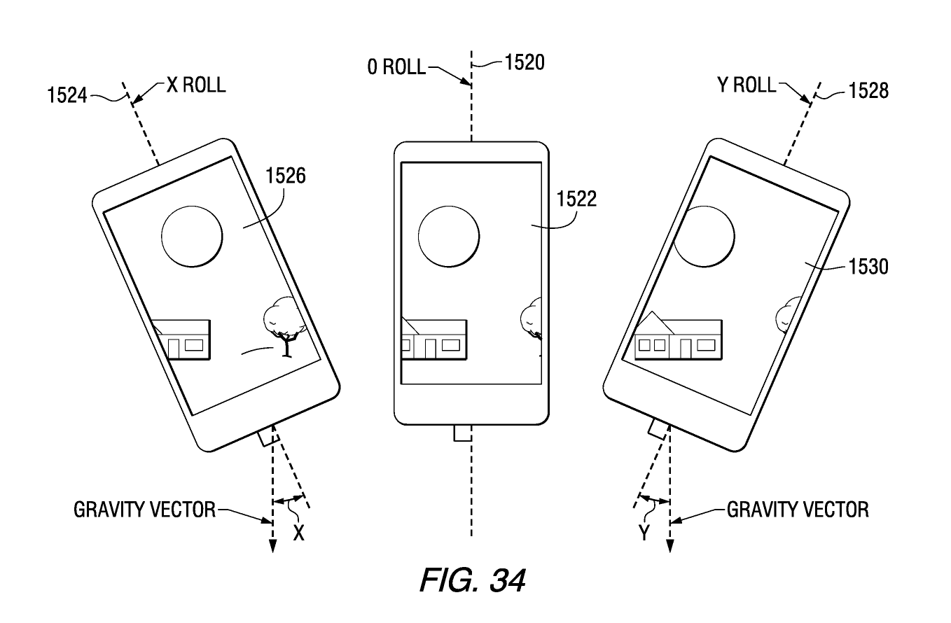

As shown in FIG. 34, automatic roll correction can be computed as the angle between the device's vertical display axis and the gravity vector from the device's accelerometer. When a user holds the mobile computing device in an initial position along line 1520, the image 1522 is produce on the device display. When a user moves the mobile computing device to an x-roll position along line 1524, which is offset from the gravity vector by an angle x, the image 1526 is produced on the device display. When a user moves the mobile computing device in a y-roll position along line 1528, which is offset from the gravity by an angle y, the image 1530 is produced on the device display. In effect, the display is showing a tilted portion of the panoramic image captured by the combination of the camera and the panoramic optical device. The portion of the image to be shown is determined by the change in vertical orientation data with respect to the initial gravity vector.

The user can select from live view from the camera, videos stored on the device, view content on the user (full resolution for locally stored video or reduced resolution video for web streaming), and interpret/re-interpret sensor data. Proxy streams may be used to preview a video from the camera system on the user side and are transferred at a reduced image quality to the user to enable the recording of edit points. The edit points may then be transferred and applied to the higher resolution video stored on the camera. The high-resolution edit is then available for transmission, which increases efficiency and may be an optimum method for manipulating the video files.

The camera system of the present invention may be used with various apps. For example, an app can search for any nearby camera system and prompt the user with any devices it locates. Once a camera system has been discovered, a name may be created for that camera. If desired, a password may be entered for the camera WIFI network also. The password may be used to connect a mobile device directly to the camera via WIFI when no WIFI network is available. The app may then prompt for a WIFI password. If the mobile device is connected to a WIFI network, that password may be entered to connect both devices to the same network.

The app may enable navigation to a “cameras” section, where the camera to be connected to WIFI in the list of devices may be tapped on to have the app discover it. The camera may be discovered once the app displays a Bluetooth icon for that device. Other icons for that device may also appear, e.g., LED status, battery level and an icon that controls the settings for the device. With the camera discovered, the name of the camera can be tapped to display the network settings for that camera. Once the network settings page for the camera is open, the name of the wireless network in the SSID field may be verified to be the network that the mobile device is connected on. An option under “security” may be set to match the network's settings and the network password may be entered. Note some WIFI networks will not require these steps. The “cameras” icon may be tapped to return to the list of available cameras. When a camera has connected to the WIFI network, a thumbnail preview for the camera may appear along with options for using a live viewfinder or viewing content stored on the camera.

In situations where no external WIFI network is available, the app may be used to navigate to the “cameras” section, where the camera to connect to may be provided in a list of devices. The camera's name may be tapped on to have the app discover it. The camera may be discovered once the app displays a Bluetooth icon for that device. Other icons for that device may also appear, e.g., LED status, battery level and an icon that controls the settings for the device. An icon may be tapped on to verify that WIFI is enabled on the camera. WIFI settings for the mobile device may be addressed in order to locate the camera in the list of available networks. That network may then be connected to. The user may then switch back to the app and tap “cameras” to return to the list of available cameras. When the camera and the app have connected, a thumbnail preview for the camera may appear along with options for using a live viewfinder or viewing content stored on the camera.

In certain embodiments, video can be captured without a mobile device. To start capturing video, the camera system may be turned on by pushing the power button. Video capture can be stopped by pressing the power button again.

In other embodiments, video may be captured with the use of a mobile device paired with the camera. The camera may be powered on, paired with the mobile device and ready to record. The “cameras” button may be tapped, followed by tapping “viewfinder.” This will bring up a live view from the camera. A record button on the screen may be tapped to start recording. To stop video capture, the record button on the screen may be tapped to stop recording.

To playback and interact with a chosen video, a play icon may be tapped. The user may drag a finger around on the screen to change the viewing angle of the shot. The video may continue to playback while the perspective of the video changes. Tapping or scrubbing on the video timeline may be used to skip around throughout the video.

Firmware may be used to support real-time video and audio output, e.g., via USB, allowing the camera to act as a live web-cam when connected to a PC. Recorded content may be stored using standard DCIM folder configurations. A YouTube mode may be provided using a dedicated firmware setting that allows for “YouTube Ready” video capture including metadata overlay for direct upload to YouTube. Accelerometer activated recording may be used. A camera setting may allow for automatic launch of recording sessions when the camera senses motion and/or sound. A built-in accelerometer, altimeter, barometer and GPS sensors may provide the camera with the ability to produce companion data files in .csv format. Time-lapse, photo and burst modes may be provided. The camera may also support connectivity to remote Bluetooth microphones for enhanced audio recording capabilities.

The panoramic camera system 10 of the present invention has many uses. The camera may be mounted on any support structure, such as a person or object (either stationary or mobile). For example, the camera may be worn by a user to record the user's activities in a panoramic format, e.g., sporting activities and the like. Examples of some other possible applications and uses of the system in accordance with embodiments of the present invention include: motion tracking; social networking; 360 mapping and touring; security and surveillance; and military applications.

For motion tracking, the processing software can be written to detect and track the motion of subjects of interest (people, vehicles, etc.) and display views following these subjects of interest.

For social networking and entertainment or sporting events, the processing software may provide multiple viewing perspectives of a single live event from multiple devices. Using geo-positioning data, software can display media from other devices within close proximity at either the current or a previous time. Individual devices can be used for n-way sharing of personal media (much like YouTube or flickr). Some examples of events include concerts and sporting events where users of multiple devices can upload their respective video data (for example, images taken from the user's location in a venue), and the various users can select desired viewing positions for viewing images in the video data. Software can also be provided for using the apparatus for teleconferencing in a one-way (presentation style—one or two-way audio communication and one-way video transmission), two-way (conference room to conference room), or n-way configuration (multiple conference rooms or conferencing environments).

For 360° mapping and touring, the processing software can be written to perform 360° mapping of streets, buildings, and scenes using geospatial data and multiple perspectives supplied over time by one or more devices and users. The apparatus can be mounted on ground or air vehicles as well, or used in conjunction with autonomous/semi-autonomous drones. Resulting video media can be replayed as captured to provide virtual tours along street routes, building interiors, or flying tours. Resulting video media can also be replayed as individual frames, based on user requested locations, to provide arbitrary 360° tours (frame merging and interpolation techniques can be applied to ease the transition between frames in different videos, or to remove temporary fixtures, vehicles, and persons from the displayed frames).

For security and surveillance, the apparatus can be mounted in portable and stationary installations, serving as low profile security cameras, traffic cameras, or police vehicle cameras. One or more devices can also be used at crime scenes to gather forensic evidence in 360° fields of view. The optic can be paired with a ruggedized recording device to serve as part of a video black box in a variety of vehicles; mounted either internally, externally, or both to simultaneously provide video data for some predetermined length of time leading up to an incident.

For military applications, man-portable and vehicle mounted systems can be used for muzzle flash detection, to rapidly determine the location of hostile forces. Multiple devices can be used within a single area of operation to provide multiple perspectives of multiple targets or locations of interest. When mounted as a man-portable system, the apparatus can be used to provide its user with better situational awareness of his or her immediate surroundings. When mounted as a fixed installation, the apparatus can be used for remote surveillance, with the majority of the apparatus concealed or camouflaged. The apparatus can be constructed to accommodate cameras in non-visible light spectrums, such as infrared for 360° heat detection.

Whereas particular embodiments of this invention have been described above for purposes of illustration, it will be evident to those skilled in the art that numerous variations of the details of the present invention may be made without departing from the invention.

What is claimed is:

1. A low-profile panoramic camera comprising:
an elongated camera body; and
a panoramic lens having a longitudinal axis and a field of view angle of greater than 180°,
wherein a portion of the camera body adjacent to the panoramic lens comprises a surface defining a rake angle that is outside the field of view angle, and the panoramic camera has a total height less than a length of the camera body.

2. The low-profile panoramic camera of claim 1, wherein the total height of the panoramic camera is less than 50 percent of the length of the camera body.

3. The low-profile panoramic camera of claim 2, wherein the total height of the panoramic camera is less than 50 percent of a width of the camera body.

4. The low-profile panoramic camera of claim 1, wherein the camera body has a maximum thickness measured from a bottom surface to a top surface of the camera body along a line normal to the bottom surface that is less than 50 percent of the length of the camera body.

5. The low-profile panoramic camera of claim 4, wherein the camera body has a tapered thickness adjacent to a back end of the camera measured from the bottom surface to the top surface of the camera body along a line normal to the bottom surface that is at least 10 percent less than the maximum body thickness.

6. The low-profile panoramic camera of claim 1, wherein the camera body has a height measured along the longitudinal axis of the panoramic lens, the panoramic lens has an exposed height measured along the longitudinal axis of the panoramic lens, and the lens height is at least 20 percent of the camera body height.

7. The low-profile panoramic camera of claim 1, wherein the bottom surface of the camera body is concave.

8. The low-profile panoramic camera of claim 7, wherein at least a portion of the bottom surface has a longitudinal radius of curvature of from 100 to 400 mm, and a transverse radius of curvature of from 50 to 300 mm.

9. The low-profile panoramic camera of claim 1, wherein a portion of the top surface of the camera body surrounding the panoramic lens is generally conical.

10. The low-profile panoramic camera of claim 1, wherein a portion of the top surface of the camera body forms a partial obstruction that enters into the field of view angle of the panoramic lens.

11. The low-profile panoramic camera of claim 11, wherein the partial obstruction is located between the panoramic lens and a back end of the camera body.

12. The low-profile panoramic camera of claim 1, wherein the field of view angle is greater than 220°.

13. The low-profile panoramic camera of claim 1, wherein the field of view angle is from 240° to 270°

14. The low-profile panoramic camera of claim 1, further comprising a panoramic video sensor contained in the camera body.

15. The low-profile panoramic camera of claim 1, further comprising a panoramic video processor board contained in the camera body.

16. The low-profile panoramic camera of claim 1, further comprising at least one motion sensor contained in the camera body.

17. The low-profile panoramic camera of claim 18, wherein the at least one motion sensor comprises an accelerometer or a gyroscope.

18. The low-profile panoramic camera of claim 1, wherein the panoramic camera is structured and arranged to be oriented at a tilt angle measured between a vertical axis and the longitudinal axis of the panoramic lens when the camera is mounted on a helmet.

19. The low-profile panoramic camera of claim 18, wherein the tilt angle is from 1° to 20°.

20. The low-profile panoramic camera of claim 1, wherein the bottom surface of the camera body comprises a curvature that substantially conforms to a body curvature of a user of the panoramic camera, and the body curvature corresponds to a head of the user, a chest of the user, a shoulder of the user, or an arm of the user.
